(19) United States
(12) Patent Application Publication
(10) Pub. No.: US 2010/0138558 A1
(43) Pub. Date: Jun. 3, 2010

(54) SYSTEM, DEVICE, METHOD AND COMPUTER-READABLE MEDIUM FOR PROVIDING NETWORK SERVICE INFORMATION

(75) Inventors: Rebecca L.J Chen, Taipei (TW); Leo C.Y. Kuo, Taipei (TW); Rick M.F Wu, Taipei (TW)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/626,758

(22) Filed: Nov. 27, 2009

(30) Foreign Application Priority Data
Nov. 28, 2008 (TW) 97146368

(51) Int. Cl. G06F 15/173

(52) U.S. Cl. 709/242

(57) ABSTRACT

A system, device, method and computer-readable medium are disclosed. The system includes a server and a client. The server provides a plurality of network services and includes a service list module for generating a network service information list. The network service information list at least includes network paths of the plurality of network services. The client, coupled to the server, includes an automatic information retrieving handler. The automatic information retrieving handler sends a request to the service list module of the server upon detecting a network path, inputted by an user, pointing to the server, receives at least a portion of network service information from the network service information list of the server, and selectively displays at least a portion of the network service information to the user.

### CROSS REFERENCE TO RELATED APPLICATIONS

This application claims priority under 35 U.S.C. §119(a) to Taiwanese Patent Application Serial No. 97146368 entitled “SYSTEM, DEVICE, METHOD AND COMPUTER-READABLE MEDIUM FOR PROVIDING NETWORK SERVICE INFORMATION”, filed on Nov. 28, 2008.

### TECHNICAL FIELD

The present invention relates to a system and method for providing network service information, and more particularly to a system and method for automatically providing network service information through a network service information list.

### BACKGROUND OF THE INVENTION

As the Internet technology continuously develops, people may perform more and more services through the Internet and receive more accurate and real-time feedbacks. Due to the variety of services, the technical structures related to the Internet become more and more complex. In the era of Web 1.0, either the technical structure or the interaction between users is relatively simple. However, the interaction and integration between services and technologies, such as RSS and XML, become critical after the new era of Web 2.0.

For example, AJAX is one of the major and important network techniques. AJAX, namely the “Asynchronous JavaScript and XML”, is a kind of technique used to create interactive web applications, which typically uses Javascript to create interactive Internet applications. With Ajax, applications can retrieve data from the server asynchronously in the background without interfering with the display and behavior of the existing page. Data is usually retrieved using the XML format. Since the processing tasks are moved from server side to client side, the processing speed is significantly accelerated. Traditional web applications allow the client to use standard “form” to submit the request to the server and the server will return a new web page upon receiving the request. This approach wastes a lot of bandwidth to transmit redundant data because many contents are still unchanged between different requests. Furthermore, each communication requires one independent request to be processed by the server, which causes the response time to be much longer than local processes. On the contrary, AJAX uses the Javascript embedded in web pages to send requests to and receive data from the server while simultaneously performing local tasks. Therefore, the data required to be exchanged between the server and the client is dramatically decreased (almost 5% processing time comparing to traditional scheme).

Besides, it is an important trend to release Application Programming Interface (API) for web services thereby the services provided by service providers may be easily integrated. However, even a single service provider may maintain thousands of APIs at the same time, either stored at centralized or distributed hosts according to their functions or characteristics. Users may also access the APIs by a unique web path to identify each API and even may require to access and integrate several APIs provided by different service providers in their own applications. For example, a service developer must reference to tremendous descriptions and manuals upon developing a new network services and find the most suitable one from thousands of APIs. Meanwhile, the web path of the selected API must be correctly recorded, which causes unnecessary developing time and cost, particularly when the developer has to input a typically lengthy web path to identify a single API, such as: http://www.ibm.com/developerworks/websphere/atom/profile.do?format=lite&email=true.

On the other hand, such a lengthy web path usually causes many typographical errors and results in malfunction of the network services. Furthermore, when the service provider updates the web path of one API, other application, which references such API, requires to be accordingly amended. To maintain all web paths of APIs in the most current status would cost a lot of work and become an annoying issue to developers.

Unfortunately, not only the service developers but also general users may face the above problem. For example, an Internet user may need to input a web path to access a specific service, such as the Uniform Resource Locator (URL) for accessing web page or other web services. It is quite common that a user unintentionally enters a wrong web path or forgets the correct web path and fails to obtain the required network service. Even though some solutions have been disclosed to display the review histories for user's selection, while they fail to provide the web paths, which the user has never accessed, and also fail to deal with the condition that a previous web path becomes invalid. It becomes more and more serious since the Internet plays an important role in modern society.

Therefore, it is advantageous to provide a system and method for automatically providing network service information for quickly and correctly selecting the required network services.

### SUMMARY OF THE INVENTION

Responsive to the above-mentioned issues in traditional techniques, several embodiments of the present invention are provided, such as a system and a method to automatically provide network service information in order to improve one or many issues mentioned above.

One aspect of the present invention discloses a system for providing network service information. The system includes a server and a client. The server provides a plurality of network services and includes a service list module for generating a network service information list. The network service information list at least includes network paths, such as a URL, of the plurality of network services. The client, coupled to the server, includes an automatic information retrieving handler. The automatic information retrieving handler sends a request to the service list module of the server upon detecting a network path, inputted by an user, pointing to the server, receives at least a portion of network service information from the network service information list of the server, and selectively displays at least a portion of the network service information to the user.

Another aspect of the present invention discloses an electronic device for providing network service information. The electronic device includes an automatic information retrieving handler. The electronic device is coupled to a server for selectively using a plurality of network services provided by the server. A request is sent to the server upon the automatic information retrieving handler automatically detecting a network path, inputted by a user, pointing to the server and the automatic information retrieving handler receives at least a portion of network service information from one of the network service information lists of the server. The network service information list at least includes network paths of the network services, and the automatic information retrieving handler selectively displays the at least a portion of network service information to the user.

Still another aspect of the present invention discloses an electronic device for providing a plurality of network services and network service information. The electronic device includes a service list module for generating a network service information list. The network service information list at least includes network paths of the plurality of network services. At least a portion of network service information of the network service information list is returned to a client upon receiving a request from the client.

Yet another aspect of the present invention discloses a method for providing network service information. The method includes the following steps: detecting a network path inputted by an user; identifying a server pointed by the network path; sending a request to the server; receiving at least a portion of network service information of a network service information list returned by the server, the network service information list comprising at least a portion of network paths of the plurality of network services; and displaying at least a portion of the network service information to the user.

Yet still another aspect of the present invention discloses a method for providing network service information. The method includes the following steps: analyzing a plurality of network services; generating a network service information list according to the plurality of network services, the network service information list at least comprising network paths of the plurality of network services; receiving a request from a client; and returning at least a portion of network service information of the network service information list to the client.

Yet still another aspect of the present invention discloses a computer readable medium carrying a program code to perform a method, upon execution in a computer, for providing network service information. The method comprising the following steps: detecting a network path inputted by an user; identifying a server pointed by the network path; sending a request to the server; receiving at least a portion of network service information of a network service information lists returned by the server, the network service information list comprising at least a portion of network paths of the plurality of network services; and displaying at least a portion of the network service information to the user.

Yet still another aspect of the present invention discloses a computer readable medium carrying a program code to performing a method, upon execution in a computer, for providing a network service information, the method comprising the following steps: analyzing a plurality of network services; generating a network service information list according to the plurality of network services, the network service information list at least comprising network paths of the plurality of network services; receiving a request from a client; and returning at least a portion of network service information of the network service information list to the client.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

### BRIEF DESCRIPTION OF THE DRAWINGS

For the advantages of the invention to be readily understood, a more specific description of the invention briefly described above will be rendered by reference to specific embodiments that are illustrated in the appended drawings. Understanding that these drawings depict only typical embodiments of the invention and are not therefore to be considered to be limiting its scope, the invention will be described and explained with additional specificity and detail through the use of the accompanying drawings.

FIG. 1 is an exemplary diagram of system 100 according to an embodiment of the present invention;

FIG. 2 is an exemplary block diagram of client 110 according to one embodiment of the present invention;

FIG. 3 illustrates a block diagram for automatically providing network service information within system 100;

FIG. 4 is a schematic view of user interface of the Integrated Development Environment 128 according to one embodiment of the present invention;

FIGS. 5A, 5B and 6 are flowcharts illustrating the method according to one embodiment of the present invention;

FIGS. 7A and 7B are an exemplary embodiment of the network service information list of the server 130 and application server 140;

FIG. 8 illustrates a process for updating the network service information according to one embodiment of the present invention; and

FIG. 9 illustrates another embodiment of the present invention.

### DETAILED DESCRIPTION OF THE PREFERRED EMBODIMENTS

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

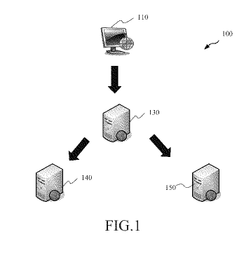

Referring now to FIG. 1 through FIG. 9, a system, devices, methods, and computer program products are illustrated as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 1 is an exemplary diagram of system 100 according to an embodiment of the present invention. In this exemplary embodiment, system 100 includes a client 110, server 130 and application servers 140 and 150. Client 110 has an integrated development environment (IDE) for developing application programs by network service developers. In this embodiment, the developers utilizes client 110 to develop AJAX application programs. Server 130 may be embodied as a web page server and stores a plurality of APIs, such as REST or ATOM APIs. The AJAX application programs in client 110 may call REST or ATOM APIs through such as Javascript codes to access specific network services provided by server 130. REST, namely “Representational State Transfer” and ATOM APIs should be well known to those skilled in the art and will be omitted here for conciseness.

Client 110, server 130 and application servers 140 and 150 may be coupled and communicated by any hardware structures or software protocols, such as Internet structure and TCP/IP protocols, or any other communication techniques. Application servers 140 and 150 may provide identical or different network services comparing to server 130. For example, application server 140 is another web page server while application server 150 is a database server in this embodiment. Therefore, those who skilled in the art should understand that the present invention does not limit to specific services provided by the servers or the quantity of the servers. The details recited here are illustrated for exemplary purpose in order to facilitate those skilled in the art to clearly understand the present invention. For example, the so-called server and application server are named for convenient and illustrative purpose depending on whether they directly receive and/or reply the request from client 110. In this specification, those servers directly receive and/or reply the requests issued by client 110 will be referred as a Service Gateway. However, it should not be considered as a limitation to the present invention. For example, client 110 may issue a request directly to application server 140 in other embodiments depending on specific considerations and, in that case, application server 140 will be referred as a Service Gateway while client 110 may indirectly access the service information from server 130 and/or application server 150 through application server 140. Alternatively, the system 100 may has more or less application servers, or even without any application server.

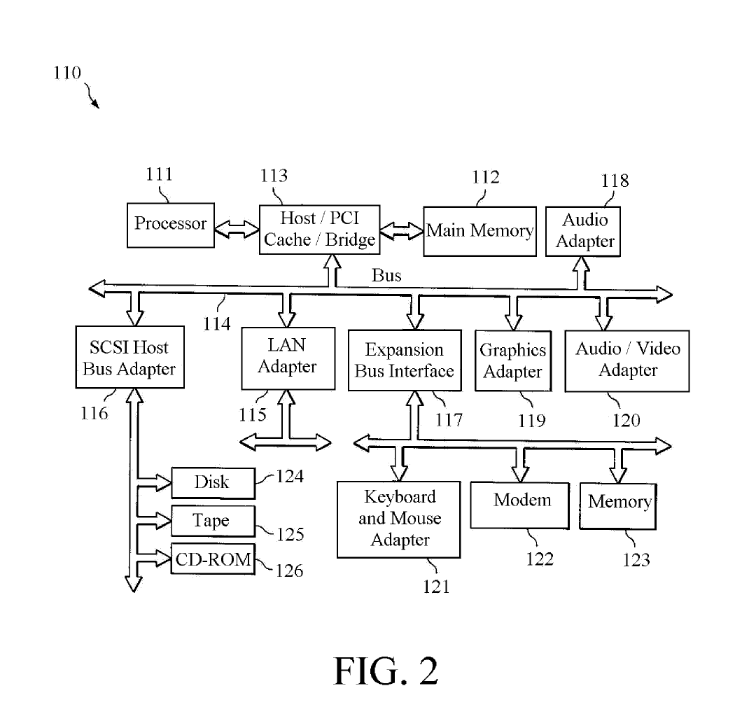

The client 110, server 130 and application servers 140 and 150 may be embodied as a computer according to one embodiment of the present invention. For example, FIG. 2 is an exemplary block diagram of client 110 according to one embodiment of the present invention. Client 110 is an example of a computer, in which code or instructions implementing the processes of the present invention may be located. Client 110 employs a peripheral component interconnect (PCI) local bus architecture. Although the depicted example employs a PCI bus, other bus architectures such as Accelerated Graphics Port (AGP) and Industry Standard Architecture (ISA) may be used. Processor 111 and main memory 112 are connected to PCI local bus 114 through PCI bridge 113. PCI bridge 113 also may include an integrated memory controller and cache memory for processor 111. Additional connections to PCI local bus 113 may be made through direct component interconnection or through add-in boards.

In the depicted example, local area network (LAN) adapter 115, small computer system interface (SCSI) host bust adapter 116, and expansion bus interface 117 are connected to PCI local bus 114 by direct component connection. In contrast, audio adapter 118, graphics adapter 119, and audio/video adapter 120 are connected to PCI local bus 114 by add-in boards inserted into expansion slots. Expansion bus interface 117 provides a connection for a keyboard and mouse adapter 121, modem 122, and additional memory 124. SCSI host bus adapter 116 provides a connection for hard disk drive 124, tape drive 125, and CD-ROM drive 130. Typical PCI local bus implementations will support three or four PCI expansion slots or add-in connectors.

An operating system runs on processor 111 and is used to coordinate and provide control of various components within client 110. The operating system may be a commercially available operating system such as Windows XP, which is available from Microsoft Corporation. An object oriented programming system such as Java may run in conjunction with the operating system and provides calls to the operating system from Java programs or applications executing on client 110. “Java” is a trademark of Sun Microsystems, Inc. Instructions for the operating system, the object-oriented programming system, and applications or programs are located on storage devices, such as hard disk drive 124, and may be loaded into main memory 112 for execution by processor 111.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system. For example, client 110, if optionally configured as a network computer, may not include SCSI host bus adapter 116, hard disk drive 124, tape drive 125, and CD-ROM 126. In that case, the computer, to be properly called a client computer, includes some type of network communication interface, such as LAN adapter 115, modem 122, or the like. As another example, client 110 may be a stand-alone system configured to be bootable without relying on some type of network communication interface, whether or not client 110 comprises some type of network communication interface. As a further example, client 110 may be a personal digital assistant (PDA), which is configured with ROM and/or flash ROM to provide non-volatile memory for storing operating system files and/or user-generated data. The depicted example in FIG. 2 and above-described examples are not meant to imply architectural limitations.

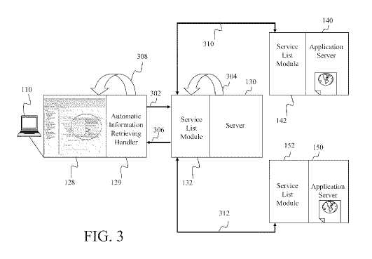

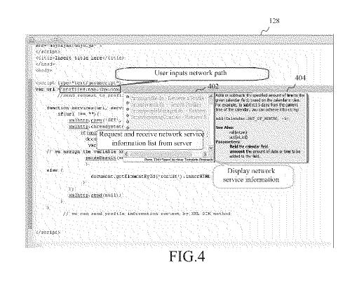

FIG. 3 further illustrates a block diagram for automatically providing network service information within system 100. As mentioned above, the client 110 in this embodiment provides an IDE 128 for developing AJAX application programs. In this embodiment, server 130 is assumed as a web page server having “ibm.com” as its URL, while application servers 140 and 150 are assumed as web page servers respectively having “profile.com” and “order.com” as their URLs. The IDE 128 of client 110 communicates with a service list module 132 of server 130 through an automatic information retrieving handler 129 for retrieving necessary network service information. In this embodiment, the network service information may be any detail descriptions of REST or ATOM APIs. Please refer to FIG. 4 as an exemplary embodiment. The network service information includes complete network paths of network services of server 130 as shown in window 402 and other relevant descriptions of corresponding network services as shown in window 404. Such descriptions may include the functions, calling method, and available parameters of the network services or any other information may help the developer to quickly understand the characteristics of the network services.

Further referring to FIG. 3, the server 130, through service list module 132, respectively communicates with the service list module 142 of application server 140 and/or service list module 152 of application server 150 in order to automatically provide the network service information. When the automatic information retrieving handler 129 detects a network path inputted by the developer, it automatically initiates a process to provide network service information, which retrieves network service information from the server 130 identified by the inputted network path. In one embodiment of the present invention, the network path is an identifier providing enough information to identify the server 130 provided by the service provider. The specific format of the network path depends on the infrastructure of network. In this embodiment, for example, the network path inputted by the developer is a URL such as “profiles.tap.ibm.com”. In other embodiment, however, other format of identifier may also be implemented, such as IP address or the like. When the automatic information retrieving handler 129 detects the inputted network path, it sends a request to the server 130 identified by the network path (step 302). The service list module 132 retrieves the related network service information, such as the complete network paths of the REST or ATOM APIs, from the network service information list maintained by the server 130 upon receiving the request from the automatic information retrieving handler 129 (step 304). Thereafter, it returns the retrieved network service information to the automatic information retrieving handler 129 (step 306). The automatic information retrieving handler 129 thus displays the received network service information to the developer, such as the information in the windows 402 and 404 of FIG. 4. Therefore, the developer may easily and quickly select the most suitable network service from the displayed network service information. Upon the selection from the developer, the automatic information retrieving handler 129 automatically inputs the complete and correct network path into the IDE 128 (step 308).

As mentioned above, it is a common demand to integrate several network services together. For example, a network service provided by server 130 may require incorporating some services provided by application servers 140 and/or 150. In such case, it will cause tremendous time waste and cost expanding to manually check and confirm all network services distributed in several servers by the developer. In this embodiment, the service list module 132 periodically communicates with the service list modules 142 and/or 152 to update the network service information provided by application servers 140 and/or 15o (step 310 and 312). Therefore, the developer may easily and quickly obtain all related network service information without additional burden even when the services provided by the servers other than server 130 are required.

FIG. 4 is a schematic view of user interface of the IDE 128 according to one embodiment of the present invention, which performs the process as illustrated in FIG. 3. In this embodiment, the automatic information retrieving handler 129 sends a request to and receives the network service information from server 130 upon the input of the network path “profiles.tap.ibm.com”. The IDE 128 displays the related network service information to the developer as described above, such as the complete network paths of network services of server 130 in window 402 and other relevant descriptions of corresponding network services in window 404. Such descriptions may include the functions, calling method, and available parameters of the network services or any other information may help the developer to quickly understand the characteristics of the network services.

It should be noted that many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

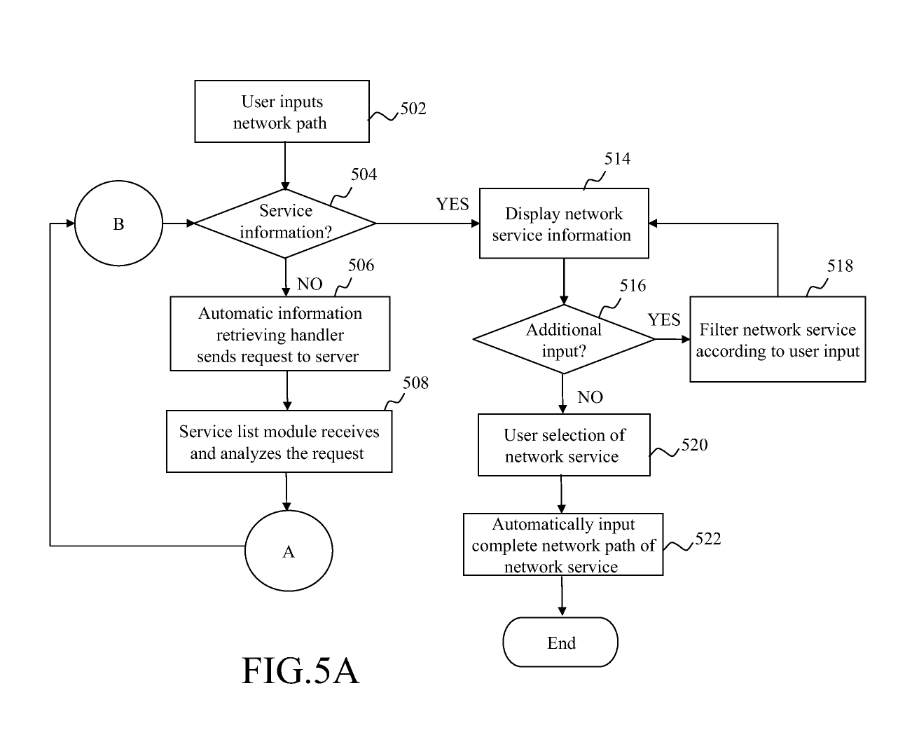

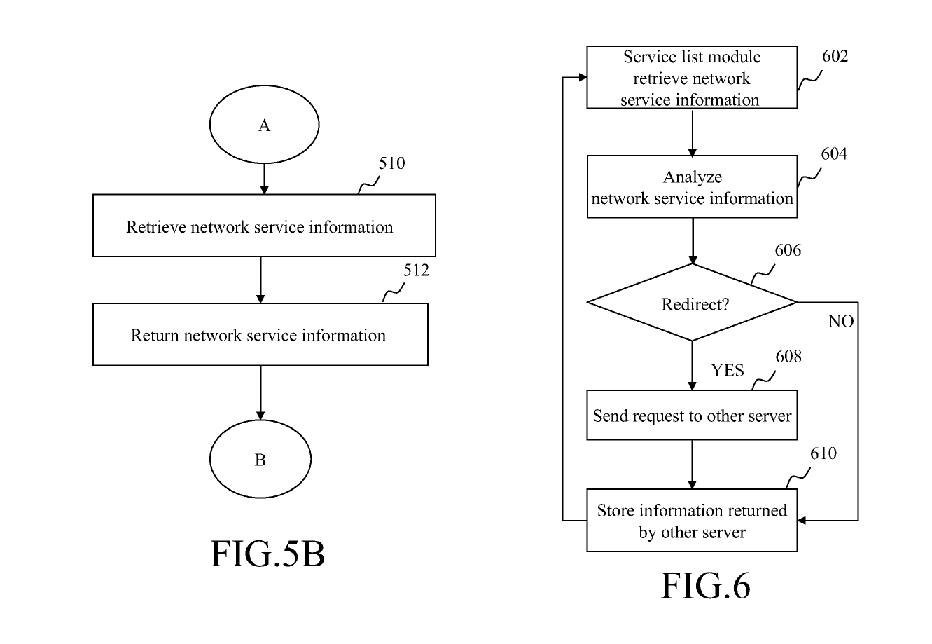

FIGS. 5A, 5B and 6 are flowcharts illustrating the method according to one embodiment of the present invention. In step 502, the user (such as the network service developer) input a network path into the IDE 128. The automatic information retrieving handler 129 may identify the network service provider identified by the network path, such as the server 130. In step 504, the automatic information retrieving handler 129 confirms whether client 110 has obtained the network service information of server 130. In this embodiment, it is assumed, as an example, that the user inputs the network path of server 130 for the first time and thus the client 110 does not have the network service information. In such case, all relevant network service information may also be automatically provided to the user according to one embodiment of the present invention. In step 506, the automatic information retrieving handler 129 sends a request to the server 130 to obtain the network service information from the server 130. In step 508, the service list module 132 of the server 130 receives the request and the process proceeds to the steps illustrated in FIG. 5B to retrieve the network service information.

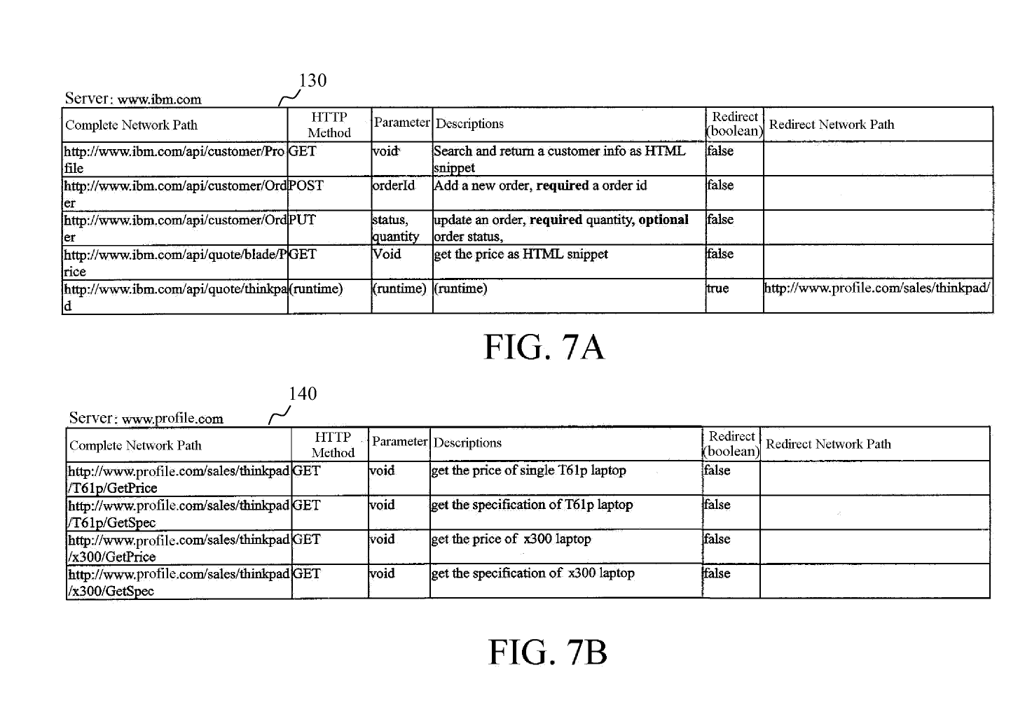

In step 510 as shown in FIG. 5B, the service list module 132 retrieves the network service information from the network service information list maintained by the server 130. The network service information list is stored in server 130 and includes the network service information corresponding to the services provided by the server 130 and other network service information gathered from other servers, such as application servers 140 and/or 150. FIGS. 7A and 7B are an exemplary embodiment of the network service information list of the server 130 and application server 140. In this embodiment, the network service information list has the information including the complete network paths of the network services, HTTP transmission method, parameters, service descriptions, redirect identifier (boolean), and redirect network paths. The complete network path is an identifier for identifying a specific network service. The HTTP transmission method, parameters and service descriptions are provided to the user as references to understand the characteristics and functions of the network service. The redirect identifier (boolean) is provided for the server 130 to determine whether a specific service is provided by an external server. For example, the value “TRUE” of the redirect identifier (boolean) means the network service is actually provided by another server. As shown in FIG. 7A, one of the network services, namely “profile.com”, is provided by the application server 140. The redirect network path is thus provided for identifying the application server 140. It should be noted that the service lists as shown in the appended drawings are served as exemplary embodiments rather than limitations to the present invention. In other embodiment, the network service information list may include even more or less information as shown in the appended drawings.

Referring back to FIG. 5B, the service list module 132 returns to the client 110 the relevant network service information retrieved from the network service information list in step 512. In this embodiment, the service list module 132 returns all information contained in the service list to the client 110. In other embodiments, however, it may selectively return a portion of the information.

Now, referring back to FIG. 5A, if it is determined that the client 110 has already obtained the network service information from the server 130 in step 504, the client 110 may selectively display all or a portion of the relevant information to the user depending on the design requirements or other specific circumstances in step 514. In step 516, the user, after reviewing the displayed information, may further perform additional input on demand. For example, if the displayed information contains a large number of network services, the user may further input additional character(s) by which the automatic information retrieving handler 129 may filter the network service information based on the additional input (step 518) and display the filtered result to the user for further selection. For example, assumed an additional character “p” is inputted by the user, the automatic information retrieving handler 129 may filter all service information contains a character “p” as its initial or part of its service name or the like. In other embodiment, the user may perform other approach to filter the network service information. Take the network service information list as shown in FIG. 7A as an example, the directory “api” contains two sub-directories “customer” and “quote”. The user may select, such as by keyboard or mouse, one of the displayed sub-directories and then the automatic information retrieving handler 129 may filter the network service information based on the selected sub-directory. If the server 130 contains multi-level directories, the above selection may be repeatedly performed until the suitable service information is found. In step 520 the user may select specific network service information from the displayed information, such as by mouse, keyboard or touch screen. The automatic information retrieving handler 129 then automatically inputs the complete network path to the IDE 128 based on user's selection in order to develop the application program, such as the above-mentioned AJAX applications (step 522). Therefore, the complete network path may be automatically, correctly and quickly inputted even for the network services unfamiliar to the user, and the possibility of typographical error may be significantly decreased in the meanwhile.

In the condition that the network service information list of the server 130 contains network services redirected to other server, FIG. 6 further provides a flowchart illustrating the process to retrieve the network service list from other servers according to one embodiment of the present invention. When service list module 132 retrieves network service information from the network service information list as shown in FIG. 7A (step 602), it further analyzes the network service information (step 604) and determines whether any redirect is required (step 606). When a network service requires redirect, a request is then sent to the server identified by the network service information (step 608). For example, when analyzes the last line shown in the network service information list of FIG. 7A, a request will be sent to the application server 140 bearing the network service information list as shown in FIG. 7B. The application server 140 then selectively returns all or a portion of information from the network service information list. For example, the application server 140 may return to server 130 all information contained in the service information list or alternatively only updated information comparing to the previous transmission, thereby reduces the loading over the network. Upon receiving the returned information from application server 140, the server 130 stores the received information into its own network service information list (step 610). The process shown in FIG. 6 may be performed periodically to synchronize the list on the servers, or alternatively upon a specific request is received, or any other conditions. The server 130 may also perform similar process with the application server 150 or any other servers.

The network service information list shown in FIGS. 7A and 7B may be stored in a file with general format, such as a JavaEE(J2EE) web application's deployment descriptor or a standard configuration file in a web page server, e.g. “host.conf'. In one embodiment of the present invention, the service list module may be implemented as a daemon process for handling service list. The daemon process may be used to analyze the network service information list, cache the received information list, handle the request from the client, or related process described herein.

The current JavaEE(J2EE) web container standard is used to describe the attributes of the web application program. In one embodiment of the present invention, exemplary codes of JavaEE(J2EE) web application are illustrated below by extending the current JavaEE(J2EE) web container standard, namely “web.xml” so that the above-mentioned network service information list may be easily stored via REST/ATOM APIs. Those extension codes are shown in bold font between tags of <web2.0> and </web2.0>.

```
<?xml version=“1.0” encoding=“ISO-8859-1”?>
<!DOCTYPE web-app
    PUBLIC “-//Sun Microsystems, Inc.//DTD Web Application
2.3//EN”
    “http://java.sun.com/dtd/web-app_2_3.dtd”>
<web-app>
  <servlet>
      <servlet-name>Order</servlet-name>
      <display-name>Order</display-name>
      <servlet-class>com.ibm.CustomerOrder</servlet-class>
        <web2.0>
      <api-type>REST, ATOM</api-type>
      <accepted-http-method>POST, PUT</accepted-http-
method>
      <http-post>
        <parameters>
          <parameter>
          status
        </parameter>
        <parameter>
          quantity
        </parameter>
      </parameters>
      <descriptions>
            Add a new order, required a order id
      </descriptions>
      </http-post>
      <http-put>
      <parameters>
        <parameter>
          orderId
        </parameter>
      </parameters>
      <descriptions>
            update an order, required quantity, optional order
status,
      </descriptions>
      </http-put>
      <redirect-url>
        N/A
      </redirect-url>
    </web2.0>
  </servlet>
  <servlet-mapping>
      <servlet-name>CustomerInfo</servlet-name>
      <url-pattern>/customer</url-pattern>
  </servlet-mapping>
<servlet>
      <servlet-name>ThinkpadInfo</servlet-name>
      <display-name>ThinkpadInfo</display-name>
      <servlet-class>com.ibm.ThinkpadInfo</servlet-class>
        <web2.0>
      <api-type>REST, ATOM</api-type>
      <accepted-http-method>GET</accepted-http-method>
      <http-get>
        <parameters>
        <parameter>
          void
        </parameter>
        </parameters>
        <descriptions>
              Get the information of laptop from Lenovo
        </descriptions>
      </http-get>
      <redirected-
url>http://www.lenovo.com/sales/thinkpad/<redirected-url>
      </web2.0>
  </servlet>
  <servlet-mapping>
      <servlet-name>ThinkpadInfo</servlet-name>
      <url-pattern>/thinkpad</url-pattern>
  </servlet-mapping>
</web-app>
```

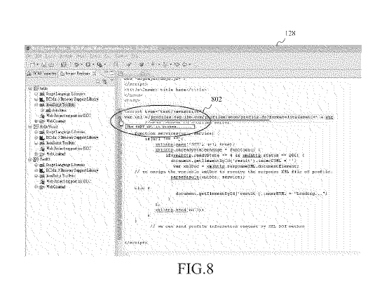

In another embodiment of the present invention, an update (or detecting) function may be further implemented. For example, when a user selects a specific network service information via the IDE 128, a detect process may be initiated upon storing or compiling the program codes to detect whether the related information of the selected network service is updated. The server 130 may inform client 110 the updated information upon a request from the client 110 (such as via the detect process described above), or otherwise actively inform the client 110 even without a specific request. Alternatively, the client 110 may periodically synchronize the updated information with server 130. FIG. 8 shows a process for updating the service information according to one embodiment of the present invention. When the automatic information retrieving handler 129 receives the updated information from the service list module 132, it may display to user a notice 802 such as “This REST API is broken” and the user may take proper actions accordingly. In addition, any other updates of parameters, service information or the like may be provided to the user in a similar method to improve the efficiency of development.

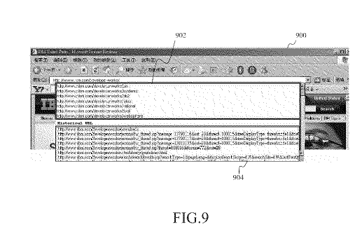

The above descriptions are recited for illustrative purpose rather than limitations. The present invention may still have various amendments and/or changes. For example, the present invention may be embodied in the conditions other than the IDE 128. FIG. 9 illustrates another embodiment of the present invention. In this embodiment, the client 110 provides a web browser 900 for a user to access various network services from the server 130 and application servers 140 and 150. In this embodiment, the automatic information retrieving handler 129 may be embodied as a function bar or a plug-in to enable the web browser 900 retrieving the network service information list and displaying the received information to the user. In this embodiment, the web browser 900 includes two display zones 902 and 904 for selecting the network services by the user. For example, the display zone 902 displays network service information received from server 130 and application servers 140 and 150 and filtered according to user's additional input, while the display zone 904 displays user's browsing history.

The description shown above is only about the preferred embodiments of the present invention and is not intended to limit the scope of the invention. Any equivalent variations or modifications without departing from the spirit disclosed by the present invention should be included in the appended claims.

1. A system for providing network service information, comprising:
a server providing a plurality of network services and comprising a service list module to generate a network service information list, said network service information list at least comprising network paths of said plurality of network services; and
a client, coupled to said server, comprising an automatic information retrieving handler;
wherein said automatic information retrieving handler sends a request to said service list module of said server upon detecting a network path, inputted by an user, pointing to said server, receives at least a portion of network service information from said network service information list of said server, and selectively displays at least a portion of said network service information to said user.

2. The system according to claim 1, wherein said automatic information retrieving handler of said client further filters said received network service information upon detecting an additional input from said user, and displays said filtered result to said user.

3. The system according to claim 1, wherein said automatic information retrieving handler of said client further, upon one of said network service information specifically selected by said user, automatically inputs complete network path of said selected network service.

4. The system according to claim 3, wherein said automatic information retrieving handler of said client further check whether said server updates at least one of said network paths of said network services, and provides a notice to said user when said inputted network path is affected by said update.

5. The system according to claim 1, wherein said network service information further comprises descriptions of said plurality of network service for facilitating said user to identify a specific network service.

6. The system according to claim 1, further comprises at least one application server for providing a plurality of network services, and wherein said application server comprises a service list module to generate a network service information list at least comprising network paths of said plurality of network services of said application server, and wherein said service list module of said server further analyzes whether said network services of said network service information list of said server includes a redirect identifier pointing to said application server.

7. The system according to claim 6, wherein said server further sends a request to said application server pointed by said redirect identifier and receives at least a portion of network service information from said network service information list of said application server, and accordingly updates said received network service information to said network service information list of said server.

8. An electronic device, coupled to a server to selectively retrieve a plurality of network services provided by said server, for providing network service information, comprising:
an automatic information retrieving handler;
wherein a request is sent to said server upon said automatic information retrieving handler automatically detecting a network path, inputted by an user, pointing to said server and receiving at least a portion of network service information from one of said network service information lists of said server, said network service information list at least comprising network paths of said network services, and said automatic information retrieving handler selectively displaying said at least a portion of network service information to said user.

9. The electronic device according to claim 8, wherein said automatic information retrieving handler client further filters said received network service information upon detecting an additional input from said user, and displays said filtered result to said user.

10. The electronic device according to claim 8, wherein said automatic information retrieving handler further, upon one of said network service information specifically selected by said user, automatically inputs complete network path of said selected network service.

11. The electronic device according to claim 10, wherein said automatic information retrieving handler of said client further check whether said server updates at least one of said network paths of said network services, and provides a notice to said user when said inputted network path is affected by said update.

12. An electronic device for providing a plurality of network services and network service information, comprising:
a service list module for generating a network service information list, said network service information list at least comprising network paths of said plurality of network services;
wherein at least a portion of network service information of said network service information list is returned to a client upon receiving a request from said client.

13. The electronic device according to claim 12, wherein said service list module further records an update request from said client and sends a notice to said client upon said network service information is updated.

14. The electronic device according to claim 12, wherein said network service information further comprises descriptions of said plurality of network service for facilitating a user to identify a specific network service.

15. The electronic device according to claim 12, wherein said service list module further analyzes whether said network services of said network service information list includes a redirect identifier pointing to an application server.

16. The electronic device according to claim 15, wherein said service list module further sends a request to said application server pointed by said redirect identifier and receives at least a portion of network service information from said application server, and accordingly updates said received network service information to said network service information list.

17. A method for providing network service information, comprising:
detecting a network path inputted by an user;
identifying a server pointed by said network path;
sending a request to said server;
receiving at least a portion of network service information of a network service information lists returned by said server, said network service information list comprising at least a portion of network paths of said plurality of network services; and
displaying at least a portion of said network service information to said user.

18. The method according to claim 17, further comprising:
detecting an additional input from said user;
filtering said received network service information upon; and
displaying said filtered result to said user.

19. The method according to claim 17, further comprising:
automatically inputting complete network path of said selected network service upon one of said network service information specifically selected by said user.

20. The method according to claim 19, further comprising:
checking whether said server updates at least one of said network paths of said network services; and
providing a notice to said user when said inputted network path is affected by said update.

21. The method according to claim 17, further comprising:
displaying descriptions of said plurality of network service for facilitating said user to identify a specific network service.

22. A method for providing a network service information, comprising:
analyzing a plurality of network services;
generating a network service information list according to said plurality of network services, said network service information list at least comprising network paths of said plurality of network services;
receiving a request from a client; and
returning at least a portion of network service information of said network service information list to said client.

23. The method according to claim 22, further comprising:
analyzing whether said network services of said network service information list includes a redirect identifier pointing to an application server;
sending a request to said application server pointed by said redirect identifier;
receiving at least a portion of network service information from said application server; and
accordingly updating said received network service information to said network service information list.

24. A computer readable medium carrying a program code to perform a method, upon execution in a computer, for providing network service information, the method comprising the following steps:
detecting a network path inputted by an user;
identifying a server pointed by said network path;
sending a request to said server;
receiving at least a portion of network service information of a network service information list returned by said server, said network service information list comprising at least a portion of network paths of said plurality network services; and
displaying at least a portion of said network service information to said user.

25. The computer readable medium according to claim 24, wherein the program code further executed to perform the following steps:
detecting an additional input from said user;
filtering said received network service information upon; and
displaying said filtered result to said user.

26. The computer readable medium according to claim 24, wherein the program code further executed to perform the following steps:
automatically inputting complete network path of said selected network service upon one of said network service information specifically selected by said user.

27. The computer readable medium according to claim 26, wherein the program code further executed to perform the following steps:
checking whether said server updates at least one of said network paths of said network services; and
providing a notice to said user when said inputted network path is affected by said update.

28. The computer readable medium according to claim 24, wherein the program code further executed to perform the following steps:
displaying descriptions of said plurality of network service for facilitating said user to identify a specific network service.

29. A computer readable medium carrying a program code to performing a method, upon execution in a computer, for providing a network service information, the method comprising the following steps:
analyzing a plurality of network services;
generating a network service information list according to said plurality of network services, said network service information list at least comprising network paths of said plurality of network services;
receiving a request from a client; and
returning at least a portion of said network service information to said client.

30. The computer readable medium according to claim 29, wherein the program code further executed to perform the following steps:
analyzing whether said network services of said network service information list includes a redirect identifier pointing to an application server;
sending a request to said application server pointed by said redirect identifier;
receiving at least a portion of network service information from said application server; and
accordingly updating said received network service information to said network service information list.
